(19) United States
(12) Patent Application Publication
(10) Pub. No.: US 2026/0298782 A1
(43) Pub. Date: Oct. 1, 2026

(54) A MULTI-STAGE APPARATUS FOR AUTOMATED SAMPLE PREPARATION AND ONLINE PEPTIDE MAPPING ANALYSIS

(71) Applicant: Hoffmann-La Roche Inc., Little Falls, NJ (US)

(72) Inventors: Karim Tarek Layachi ATTARI, Birsfelden (CH); Anja BATHKE, Augst (CH); Sina Nadine HOELTERHOFF, Loerrach (DE); Saban OEZIPEK, Basel (CH)

(21) Appl. No.: 19/480,346

(22) PCT Filed: May 3, 2024
(86) PCT No.: PCT/EP2024/062254

§ 371 Date: Oct. 30, 2025

(30) Foreign Application Priority Data
May 5, 2023 (EP) 23171877.6

(51) Int. Cl. G01N 1/40; G01N 1/38; G01N 1/42; G01N 1/44; G01N 30/20; G01N 35/00

(52) U.S. Cl. CPC G01N 1/4044; G01N 1/38; G01N 1/42; G01N 1/44; G01N 30/20; G01N 35/0099; G01N 2001/386

(57) ABSTRACT

The invention relates to a multi-stage apparatus having an injector module, a sample module having a sample tray for holding one or more sample vial, a buffer exchange module having a buffer exchange column, a digestion module having a digestion column downstream from the buffer exchange module, and a separation module having a separation column downstream from the digestion module. The injector module has a needle for extracting and injecting a sample from one sample vial into another sample vial and for extracting and injecting a sample from a sample vial into the buffer exchange module. The sample module is configured to control the temperature of the sample vials. In use a sample can be reacted by introducing reagents and the sample to a vial in the sample tray using the needle and controlling the temperature before being injected onto the buffer exchange module. The apparatus of the invention allows multiple product attributes to be analysed in a single integrated apparatus whilst reducing hands-on manipulation and increasing sample throughput compared to known hands-on methods and to other state of the art methods.

### PRIORITY

The present application claims priority to EP 23171877.6 the contents of which is hereby incorporated in its entirety.

### BACKGROUND

Proteins such as antibodies are essential and complex biomolecules that play crucial roles in many biological processes. They consist of one or more peptide chains composed of amino acids which can fold into complex structures, allowing them to perform diverse functions within organisms.

Monoclonal antibodies (mAbs) are powerful proteins, which are able to cure severe diseases and improve patient outcomes. Therefore, mAbs play an increasingly important role in the fields of medicine, biotechnology and for the biopharmaceutical industry.

Understanding the structure of proteins such as mAbs is essential for the development and the production of new drugs.

Generally, multiple attributes (or characteristics) of a complex product such as a protein (e.g. a mAb) are required in order to define and characterize the product. Multi-attribute methods (MAM) describe analytical methods with the ability to monitor multiple product characteristics at once. With this approach, MAM can replace a collection of conventional methods that analyze one attribute at a time. With MAM, fewer analytical tests are required, which reduces the workload and potentially leads to reduced costs while accelerating the approval process particularly of biopharmaceuticals.

Therapeutic proteins such as mAbs are heterogeneous products and can be unintentionally altered during production, downstream processing, formulation, storage and administration. Structural changes and chemical modifications which affect product safety or efficacy are considered critical quality attributes (CQAs).

To ensure patient safety it is crucial that quality control confirms the reliability and consistency of biopharmaceutical products such as mAbs across the entire product life cycle. For example, to monitor and confirm sufficient quality of biopharmaceutical products, the U.S. Food and Drug Administration (FDA) recommends characterization and monitoring of critical quality attributes (CQAs).

For Quality Control (QC) analysis, classical chromatographic or electrophoretic methods (e.g. ion-exchange chromatography) for release and stability testing are the primary methods used. Such methods are not able to acquire site-specific information on PTMs at the peptide level.

Liquid chromatography mass spectrometry (LC-MS) based peptide mapping analysis is the method of choice within the industry and academia to characterize the structure of proteins, monitor modifications and confirm the identity.

This technique involves breaking down a protein into its constituent peptides, separating these by liquid chromatography and then analysing them using mass spectrometry. This technique allows modifications to be identified and relatively quantified such as post-translational modifications (PTMs or CQAs) directly at the peptide level and to gain site-specific information.

Peptide mapping analysis can be considered a multi-attribute method (MAM) due to the ability to monitor multiple product characteristics (sequence variants, oxidation variants, charge variants, glycovariants) within one analysis. However, the peptide mapping sample preparation is labour-intensive and time consuming. Manual sample preparation or separate robotic sample preparation is commonly performed and is a bottleneck for known peptide mapping analysis methods. Additionally manual sample preparation is inefficient and (human) error prone, which could lead to method induced modifications.

In order to provide more drugs and at the same time reduce costs for public healthcare, it is desirable to provide improved processes for use in characterizing proteins such as mAbs and/or improved processes that can be used in monitoring CQAs and other modifications in a QC environment.

The present invention aims to solve one or more of the above problems. In particular, the present invention provides a multi-stage apparatus that can prepare and analyse (peptide mapping) multiple attributes of samples such as mAbs in a time efficient manner with reduced hands-on input. The present invention may also provide a method that can be readily adapted to the QC environment. In this way, the present invention may provide accelerated and cost efficient analysis of biopharmaceuticals.

### SUMMARY OF INVENTION

The present invention provides a multi-stage apparatus for characterising a sample, such as a protein sample, such as a sample of antibodies e.g. therapeutic monoclonal antibodies.

The multi-stage apparatus of the invention has:
an injector module having a needle
a sample module having a sample tray for holding one or more sample vials
a buffer exchange module having a buffer exchange column
a digestion module having a digestion column downstream from the buffer exchange module; and
a separation module having a separation column downstream from the digestion module.

The injector module is configured for the needle to extract and inject a sample from one sample vial into another sample vial and to extract and inject a sample from a sample vial into the buffer exchange module. The sample module is configured to control the temperature of the sample vials. In use a sample can be reacted by introducing reagents and the sample to a vial in the sample tray using the needle, controlling the temperature and allowing the reaction to occur before extracting and injecting the reacted sample onto the buffer exchange module.

Reacting the sample, for example by reduction, in an automated manner offline (i.e. not on column) means samples can be prepared efficiently for digestion.

In this way, the apparatus of the invention allows multiple product attributes to be analysed in a single integrated apparatus in a robust and efficient manner. The apparatus of the invention reduces hands-on manipulation of samples compared to known peptide mapping (multi-attribute) methods. The apparatus of the invention also greatly increases sample throughput compared to known hands-on methods and to other state of the art methods.

The invention also provides a process of analysing a sample using the multi-stage apparatus of any one of the preceding clauses. In some embodiments, the process comprises the steps of:
i. extracting a portion of a reagent, such as a reducing or alkylating agent, from a reagent vial in the sample module using the needle
ii. extracting a portion of a first sample to be analysed from a sample vial in the sample module using the needle
iii. injecting the portion of the reagent, such as a reducing agent or alkylating agent, and the portion of the first sample to be analysed into a reaction vial in the sample module
iv. controlling the temperature of the reaction vial using the sample module and allowing the reaction to occur
v. after reaction occurs, extracting a portion of the reacted sample using the needle and injecting the reacted first sample into the buffer exchange module
vi. flowing the reacted first sample through the buffer exchange column, preferably a reverse phase column, to the digestion module
vii. digesting the sample on the digestion column and flowing the digested sample to the separation module
viii. separating the digested sample for analysis.

### BRIEF DESCRIPTION OF THE FIGURES

FIG. 1 shows a flow schematic of an embodiment of the invention.

FIG. 2 shows an embodiment of a multi-stage apparatus of the invention. The different figures show the different configurations of the apparatus during different stages of the process. FIG. 2 is split over 2 pages and show 5 configurations in total

FIG. 3 shows an embodiment of the sample module of the invention. FIG. 3A shows the sample module as a whole unit and FIG. 3B shows the sample module separated into different parts.

FIG. 4 shows the total ion chromatogram of mAB1 prepared and analyzed with a multi-stage system of the invention (“iSAP-LC-MS”).

FIG. 5 shows data for the linearity testing. FIG. 5A shows data for the degree of T22 oxidation; FIG. 5B shows data for the degree of T42 oxidation; and FIG. 5C shows data for the degree of T38 deamidation.

FIG. 6 shows results of precision testing of a multi-stage system of the invention and looking at the T22 oxidation and T38 deamidation.

FIG. 7 shows results of robustness testing using different digestion columns (7A) and different storage time (7B) looking at the T22 oxidation.

FIG. 8 shows graphs of the timescale for the process carried out using a multi-stage apparatus of the invention compared to known methods. FIG. 8A shows the parallel sample preparation that is provided by the multi-stage apparatus of the invention.

FIG. 8B shows how this parallel sample preparation provides time advantages over known methods. FIGS. 8C and 8D display various environmental and financial aspects of the use of the multi-stage apparatus of the invention and the prior art pipetting robot method for analysis samples.

### DETAILED DESCRIPTION

The present invention provides a multi-stage apparatus for characterising a sample, such as a protein sample, such as a sample of antibodies e.g. therapeutic monoclonal antibodies.

The multi-stage liquid chromatography (LC) apparatus of the invention has:
an injector module having a needle
a sample module having a sample tray for holding one or more sample vials
a buffer exchange module having a buffer exchange column
a digestion module having a digestion column downstream from the buffer exchange module; and
a separation module having a separation column downstream from the digestion module.

The injector module is configured for the needle to extract and inject a sample from one sample vial into another sample vial and to extract and inject a sample from a sample vial into the buffer exchange module. The sample module is configured to control the temperature of the sample vials. In use a sample can be reacted by introducing reagent(s) and the sample to a vial in the sample tray using the needle, controlling the temperature and allowing the reaction to occur before extracting and injecting the reacted sample onto the buffer exchange module.

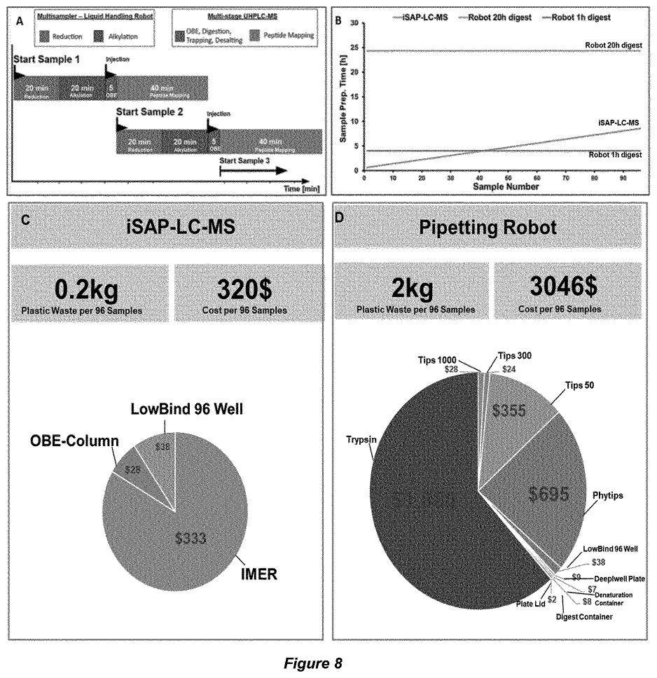

Currently used approaches for multi attribute measurements of mAbs employ hands on sample preparation or separate pipetting robot apparatus to react, such as reduce, samples which are then (manually) transferred to an LCMS system for analysis. Compared to such systems, the apparatus of the invention reduces time for sample measurements when less than around 100 samples are to be measured and reduces laboratory workers input. In the case of mAbs typically the number of samples to be measured is around 10 to 20. Parallel sample preparation and analysis as provided by the apparatus of the invention is illustrated in FIG. 8A. The time saving vs number of samples analysed compared to some common step-by-step protocols is highlighted in FIG. 8B. The advantageous environmental and financial aspects of the multi-stage system of the invention are shown by comparing FIGS. 8C and 8D.

The ability to prepare the sample for digestion in the sample module of the apparatus before injection provides numerous advantages to the apparatus of the invention as discussed above. The apparatus of the invention permits the reaction, e.g. reduction and alkylation, of one sample to occur independently (in an automated manner) in the sample module whilst in-parallel another sample is passed through the digestion module for digestion and the separation module for peptide mapping analysis. This can increase throughput of samples compared to state of the art systems. In particular, the apparatus of the present invention allows increased throughput of sample using the apparatus of the invention compared to such systems employing separate, e.g. pipetting robotic, reduction (see FIG. 8A).

The apparatus of the invention also reduces the hands on time and interaction required by laboratory workers and so reduces human error.

Additionally, consolidating sample preparation and analysis into a single apparatus as in the invention streamlines reporting and system validation. That is, only one sequence table and report is generated saving significant time in the highly regulated GxP environment. This may allow the apparatus of the invention to be employed in the QC environment more readily than prior art systems or multiple systems used for sample preparation and analysis.

In this way, the apparatus of the invention allows multiple product attributes to be analysed in a single integrated apparatus in a robust and efficient manner. The apparatus of the invention reduces hands-on manipulation of samples compared to known multi-attribute methods. The apparatus of the invention also greatly increases sample throughput compared to known hands-on methods and to other state of the art methods.

The apparatus of the invention provides these benefits by having a modified integrated injector module and sample module, such as an autosampler module, and a buffer exchange module.

In some embodiments, the multi-stage apparatus of the invention further comprises a biocompatible microfluidic mixer. The biocompatible microfluidic mixer may be between the needle and the valve for injecting the sample into the buffer exchange module or between the valve and buffer exchange module. These positionings are in the direction of flow, for example when the biocompatible microfluidic mixer is between the valve and buffer exchange module, the sample to be analysed passes through the valve, then passes through the biocompatible microfluidic mixer and then enters the buffer exchange module.

The microfluidic mixer may have a volume of from 20 to 100 μL, preferably from 30 to 40 μL such as around 35 μL.

The mixer allows dilution of the sample to be analysed. In this way, the organic solvents and any by-products such as salts from the reaction are reduced before the sample is passed on to the buffer exchange column.

In some embodiments, the multi-stage apparatus of the invention further comprises an analysis module for analysing the sample. The analysis module is fluidly connectable to and downstream from the separation module. The analysis module may comprise: a mass spectrometer such as a high-resolution mass spectrometer (HRMS) or a single quadrupole mass spectrometer; an evaporative light scattering detector (ELSD): a UV detector; or a diode array detector (DAD).

In some embodiments, the multi-stage apparatus further comprises at least one column oven, preferably at least two column ovens such as at least three column ovens. Each column oven may have two independent temperature control zones. Preferably, the multi-stage apparatus comprises at least two column ovens wherein each of the at least two column ovens has two independent temperature control zones. In this way, the temperature of one or more of the components can be controlled.

The invention also provides a process of analysing a sample using the multi-stage apparatus of any one of the preceding clauses. In some embodiments, the process comprises the steps of:
i. extracting a portion of a reagent, such as a reducing or alkylating agent, from a reagent vial in the sample module using the needle
ii. extracting a portion of a first sample to be analysed from a sample vial in the sample module using the needle
iii. injecting the portion of the reagent, such as a reducing agent or alkylating agent, and the portion of the first sample to be analysed into a reaction vial in the sample module
iv. controlling the temperature of the reaction vial using the sample module and allowing the reaction to occur
v. after reaction occurs, extracting a portion of the reacted sample using the needle and injecting the reacted first sample into the buffer exchange module
vi. flowing the reacted first sample through the buffer exchange column, preferably a reverse phase column, to the digestion module
vii. digesting the sample on the digestion column and flowing the digested sample to the separation module
viii. separating the digested sample for analysis.

### Definitions

A “multi-stage apparatus” refers to an apparatus as defined herein in which multiple modules are combined. The multiple modules are interconnected to perform sample preparation and sample analysis steps. The modules include the injector module, sample module, buffer exchange module, digestion module and separation module and provide separate ‘stages’ in the analysis process (e.g. sample preparation stage and a chromatography stage). These modules are integral to and part of the overall apparatus of the invention. Some modules are liquid chromatography modules (e.g. the buffer exchange module, digestion module and separation module) and contain a column through which the sample is passed. Different liquid chromatography modules may be connected via capillaries, columns and/or valve assemblies. Together these modules provide an (integrated) liquid chromatography (LC) apparatus that can be connected to an analysis module such as a high-resolution mass spectrometer (HRMS) or single quadrupole mass spectrometer. Different types of columns can be used in different modules to provide a sequence of chromatography and treatment, e.g. digestion or separation steps in a single ‘run’ through the apparatus. Some modules are for preparing the sample for liquid chromatography (e.g. the injector module, sample module, and optional biocompatible fluidic mixer module). Each module may also comprise components such as a pump and waste outflow. Generally, multi-stage apparatus' also have a number of valve assemblies for connecting the different modules at different times. The valve assemblies may be 2 position, 10 port valves.

“Liquid chromatography” or “LC” is an analytical process that subjects a sample to chromatographic separation through an LC column in order, for example, to separate analytes of interest from matrix components.

A “liquid chromatographic apparatus or LC apparatus” is an analytical apparatus or a unit in an analytical apparatus for carrying out liquid chromatography. The LC apparatus may also comprise elements such as a sample injector, valves, liquid sources, fluidic connections e.g., for mixing liquids, degassing liquids, tempering liquids, and the like, one or more sensors, such as pressure sensors, temperature sensors and the like, and especially at least one LC pump. The list is not exhaustive. According to an embodiment, the LC apparatus of the invention is an analytical apparatus designed to prepare multiple samples for mass spectrometry and/or to transfer a prepared sample to a mass spectrometer, in particular for separating analytes of interest before detection by a mass spectrometer.

A “valve assembly” refers to a multi-port valve component that controls flow between elements connected to the ports. This is typically achieved by a switch mechanism that moves one or more valve conduits to switch communication between different elements. Elements, e.g. components of one or more of the modules, may be fluidically connected to the ports via further conduits, like pipes, tubes, capillaries, microfluidic channels and the like and by fittings like screws/nuts and ferrules, or alternative liquid-tight sealings, e.g., maintained in place by a clamp mechanism. In this way, the various components of the modules may be connected as defined herein. For example, the pump of the trapping module may be connected to the trapping column via the third valve assembly.

A “column” refers to any of a column, a cartridge, a capillary and the like that are suitable for performing chromatography or performing a reaction such as digestion on a substance that is passed through the column. Preferably the column is a column. Columns are typically packed or loaded with a stationary phase, through which a mobile phase is pumped in order to trap and/or separate and elute and/or transfer analytes of interest under selected conditions, e.g., according to their polarity or log P value, size or affinity, as generally known. This stationary phase can be particulate or beadlike or a porous monolith. Columns may be exchangeable and/or operate in parallel or in sequence to one or more other columns.

The term “sample” is used in the application to refer to samples to be analysed and samples of reagents that are used in the apparatus of the invention. The term “sample to be analysed” refers to a material suspected of containing one or more analytes of interest. In the present case, the sample is preferably a sample of antibodies for analysis, in particular therapeutic monoclonal antibodies. The sample to be analysed can be pre-treated prior to use. Methods of treatment can involve filtration, centrifugation, distillation, concentration, inactivation of interfering components, and the addition of reagents. Preferably, reaction of the sample to be analysed is performed online in an automated manner using the apparatus of the invention and samples of reagents.

Some features of the apparatus of the invention are defined in terms of their position relative to other components in the direction of flow (e.g. upstream or downstream). The direction of flow in this case refers to the flow of liquid, e.g., solvent, through the apparatus during operation. For example, if component A is ‘upstream’ from component B, the liquid, e.g. solvent, will pass through component A before component B during operation of the apparatus. Similarly, if component C is ‘downstream’ from component D, the liquid, e.g., solvent, will pass through component D before component C during operation of the apparatus.

### Injector Module

The multi-stage apparatus of the invention has an injector module having a needle wherein the injector module is configured for the needle to extract and inject a sample from one sample vial into another sample vial and to extract and inject a sample from a sample vial into the buffer exchange module.

The injector module is readily controllable by the software used to control the liquid chromatography apparatus (e.g. Chromeleon, Empower, OpenLab).

The sample in this context encompasses reagent samples and samples to the analysed that are stored in vials in the sample module. The reagent samples are used to react with the (analytical) sample to be analysed.

In this way, the apparatus of the invention can extract and react samples in different sample vials. This allows different reactions to be carried out on separate aliquots of the sample to provide increased information and allows the monitoring of any changes to the same sample over time for example.

The needle may be washed between samples to prevent carry over of reagents or sample to the next sample. In this way, the apparatus of the invention significantly reduces the single use consumables required for each sample to be processed and helps improve the sustainability of the process.

In some embodiments the injector module is a pipetting robot. For example, the injector module may comprise a robotic 3-axis arm for liquid handling.

In some embodiments the injector module is configured to move portions of the samples to a new vial before reaction occurs.

In this way, the required amount of sample can be used for analysis without contaminating or using the whole sample. It is also possible to independently control the temperature (in combination with the sample module) of the ‘reaction’ vial and the ‘storage’ vials (i.e. the vials holding the reagent sample and the samples to be analysed) e.g. by having the vials in different areas of the sample module.

In some embodiments the injector module is configured to draw the reagent, such as a reducing agent, into the needle and then draw the sample into the needle. For example, in use, the needle may draw from 10 to 50 L, such as around 31.5 L of the reagent into the needle and may draw from 1 to 5 μL such as around 3.5 μL of the sample to be analysed into the needle. The needle may have a volume of at least 3 μL, such as from 3 to 100 μL, preferably the needle has a volume of at least 20 μL and more preferably at least 40 μL such as from 30 to 60 μL.

In this way, both the reagent and the sample are in the needle at the same time which may improve mixing.

### Sample Module

The multi-stage apparatus of the invention has a sample module having a sample tray for holding one or more sample vials. The sample module can hold samples in the one or more sample vials. The ‘samples’ may include samples to be analysed e.g. samples of mAbs, and reagent samples such as reducing agents or alkylating agent.

The sample module is adapted to control the temperature of the vials.

The sample module may be a module for holding separate vials such as glass or plastic vials or may hold a multiple well plate such as a 96 well plate or 96 deepwell plate. The well plates in such cases act as the one or more sample vials for holding samples.

In use a sample can be reacted by introducing reagents and the sample to a vial in the sample tray using the needle and controlling the temperature before being injected to the buffer exchange module. Preferably, in use a sample to be analysed, such as a sample of a mAb, can be reacted by extracting a portion of the sample to be analysed and a portion of the reagents from their respective sample vials and introducing the reagents and the portion of the sample to be analysed to a different vial in the sample module using the needle of the injector module. The temperature is controlled by the sample module and the mixture is allowed to react before extracting and injecting the reacted sample to the buffer exchange module.

In this way, the sample module (in combination with the modified injector module) is adapted to allow samples to be analysed to be reacted, such as reduced and/or alkylated, in the sample vials before injection. A reagent sample such as a reducing agent and/or alkylating agent, can be injected by the needle of the injector module into a vial containing some of the sample to be analysed. The sample vial in which reaction occurs can be maintained at a constant elevated temperature to promote reduction and alkylation using the sample module. The sample vials containing the stock reagents and sample to be analysed can be maintained at a lower temperature e.g. to prevent unwanted reactions or degradation.

In some embodiments the sample module comprises two sample trays configured so that the temperature of each sample tray is independently controllable.

In this way, the vials containing reagents and the sample to be analysed can be kept in one sample tray which can be kept, for example, at a reduced temperature. The injector module can transfer a portion of the sample to be analysed and the required reagent into a vial in the other sample tray which can be kept, for example, at an elevated temperature to promote reaction.

In some embodiments, the sample module has a heating or cooling device, such as a Peltier device, for controlling the temperature of the vials. Preferably, the sample module has at least two heating or cooling devices, such as two Peltier devices, for controlling the temperature in different regions of the sample module. Preferably, the heating or cooling device is a thermoelectric heating or cooling device such as a Peltier device. Thermoelectric heating or cooling devices work by flowing current through the junction of two conductors so that heat is removed at one junction and deposited at the other. For cooling applications, the junction where heat is removed is used to extract heat from the location to be cooled (in this case the sample vial trays) and the junction where heat is deposited is placed away from the cooled environment and often kept ambient using fans or similar.

In some embodiments, the sample module has two sample trays and two heating or cooling devices, such as two Peltier devices. Each sample tray has a corresponding heating or cooling device, such as a Peltier device. In this way, the temperature of the two sample trays can be independently controlled.

The heating or cooling device(s), such as Peltier device(s), are readily controllable by the software used to control the (multi-stage) liquid chromatography (LC) modules(s) (e.g. Chromeleon, Empower, OpenLab). They can provide temperature control between 0 and 80° C., such as from 10 to 70° C., and a time table can be set to switch the temperature within a run for specific applications and different incubation temperatures.

The sample module may control the temperature of the one or more sample vials independently of the temperature of the sample tray.

In some embodiments, the sample trays can hold 54 vials or have 96 well plates per tray.

In some embodiments, the sample module comprises sample vials for holding samples and for holding reagents.

The reagents may be: reducing agents such as Tris-(2-carboxyethyl)-phosphine (TCEP) or Dithiothreitol (DTT); alkylating agent such as lodacetamide, lodoacetic acid (IAA) or N-Ethylmaleimide (NEM): agents for enzymatic reactions such as deglycosylation with PNGase F; or labelling reagents.

In some embodiments, the sample module is an autosampler or a multisampler.

### Buffer Exchange Module

The multi-stage apparatus of the invention has a buffer exchange module having a buffer exchange column.

The inclusion of a buffer exchange module upstream from the digestion module is needed to adjust the reacted sample before it flows to the digestion column. In particular, some of the byproducts of reduction and/or alkylation (and any other steps carried out in the sample vial) are removed and the buffer is exchanged to make the sample more compatible with the digestion module and allows the use of the IMER for on-column digestion. This results in longer life of the apparatus and more accurate data. The use of the buffer exchange module therefore also facilitates the high throughput of the apparatus and reduction in hands on manipulation of the samples before digestion in state of the art systems.

The buffer exchange column may be a reverse phase chromatography column. Preferably, the buffer exchange column of the buffer exchange modules is a C4, C1 or phenyl stationary phase column or a size exclusion column, most preferably the buffer exchange column is a C4, C1 or phenyl stationary phase column.

The use of a reverse phase column allows faster desalting of the sample and higher flow rates to be used. The reverse phase column can also be used at elevated temperatures (such as around 80° C.) that can denature the protein before passing to the digestion module which improves digestion.

In some cases, the buffer exchange column has a length of from 1 to 40 mm, preferably from 2 to 10 mm such as around 5 mm.

In some cases, the buffer exchange column has a packing material with average particle size of 1 to 10 μm, preferably from 1.5 to 2.0 μm such as around 1.7 μm. Average particle size is typically specified by the manufacturer of the column. Average particle size may be measured using dynamic light scattering or sieve analysis.

In some cases, the buffer exchange column has an internal diameter of 1 to 10 mm, preferably from 1 to 4 mm such as around 2.1 mm.

In some cases, the buffer exchange column has an average pore size of from around 100 Å to 1000 Å, preferably from 200 Å to 350 Å such as around 300 Å. Average pore size is typically specified by the manufacturer of the column. The pore size may be measured by gas adsorption for example using the Brunauer Emmett Teller theory.

### Digestion Module

The multi-stage apparatus comprises a digestion module having a digestion column containing an immobilised proteolytic enzyme for digesting the reduced sample to provide a digested sample. The digestion module is downstream from the first splitter and is fluidly connectable to the second outlet of the second splitter.

In some embodiments, the digestion column is selected from a Trypsin immobilized enzyme reactor or a LysC immobilized enzyme reactor or an aspN immobilised enzyme reactor. Preferably, the digestion column is selected from a Trypsin immobilized enzyme reactor or a LysC immobilized enzyme reactor.

In some embodiments, the digestion module has a first mixer such as a static mixer or a zero delay volume T-Piece downstream from the digestion module in the direction of flow. In some such embodiments, the first mixer is further fluidly connectable to a pump of the separation module or trapping module when present to allow solvent exchange before the sample is passed on to the separation or tapping modules.

In some embodiments, the digestion module has a second mixer such as a static mixer or a zero delay volume T-Piece. In some cases the second mixer is before, or upstream from, the digestion column in the direction of flow such that the sample passes through the mixer and is mixed for example with additional solvents to provide a homogenous mixture before entering the digestion column. The second mixer may be fluidly connectable to the digestion pump when present pumping digestion buffer though the T-piece to dilute samples before they enter the digestion column.

In some embodiments, the digestion module comprises two digestion columns. In some such cases the two digestion columns are connected in parallel such that in use the sample flow is split between the two columns.

In some such cases, the two digestion columns are independently selected from a Trypsin immobilized enzyme reactor and a LysC immobilized enzyme reactor, preferably the two digestion columns are a Trypsin immobilized enzyme reactor and a LysC immobilized enzyme reactor.

The parallel digestion setup provides unique peptide combinations for example a unique Trypsin and a LysC peptide can be received. In this way, there is an increased the likelihood of post translational modification (PTM) characterization and the sequence coverage is increased. That is, using two digestion columns can provide a broader range of digestion products and enable greater sequence coverage. This in-parallel digestion may be particularly advantageous with the increasing number of more complex bispecific mAbs.

In some embodiments the digestion module comprises a digestion pump. The digestion pump may be a binary or quaternary pump.

### Trapping Module

The multi-stage apparatus of the invention may further comprise a trapping module having a trapping column for trapping the digested sample. The trapping module is downstream from the digestion module and upstream from the separation module.

The trapping column is selected to have a stationary phase that retains the analytes of interest, e.g. digested antibodies, whereas any salts, buffer, detergents and other matrix components are unretained and can be washed away.

The trapping column allows the de-coupling of the digestion column and the separation column. The trapping column may also serve to protect the separation column by trapping unwanted components e.g. undigested proteins in the case of protein mapping.

In some embodiments the trapping column has a length of 3 to 30 mm such as from 5 to 10 mm. In this way, the trapping column allows trapping of the sample and dilution of acetonitrile without significantly increasing the backpressure to the digestion column.

In some cases the trapping column has a length of from 3 to 10 mm, such as from 5 to 10 mm and preferably around 5 mm. In this way, sufficient trapping occurs and the back pressure can be reduced.

In some cases the trapping column has a length of from 25 to 30 mm. In this way, increased trapping occurs which is useful particularly for cases where trapping performance is very important.

In some embodiments the trapping column has a packing material with particle size of 1.0 to 3.0 μm, for example 1.0 to 2.0 μm preferably 1.5 to 1.7 μm.

In some embodiments the trapping column has an internal diameter of 1.5 to 5 mm. In some cases, the internal diameter is from 1.5 to 2.5 mm such as around 2.1 mm.

In some embodiments the trapping column has the same packing material as the peptide mapping column. Preferably, the trapping column has a C18 stationary phase.

In some embodiments the trapping module comprises a trapping pump. The trapping pump may be a binary or quaternary pump.

### Separation Module

The multi-stage apparatus comprises a separation module having a separation column for separating analytes, such as a peptide mapping sample.

The separation module is configured to receive the digested sample from the digestion column. In some embodiments, the separation column is not fluidly connectable to the digestion column directly. In such cases, the transfer of the digested sample takes place via another module, such as a trapping module as described above.

In some embodiments the separation module comprises a separation pump. The separation pump may be a binary or quaternary pump. Preferably, the separation module has a binary pump.

In some embodiments the separation column is selected from a peptide mapping column such a UHPLC column, a HPLC column, a reverse phase chromatography column, or a hydrophilic interaction chromatography column, preferably, the separation column is a UHPLC column. Preferably, the separation column is a UHPLC column.

In some cases, the separation column has a C18 stationary phase. C18 stationary phases are typically used for chromatographic separation of peptides. In this way, good peptide retention and separation can be achieved.

In some cases, the separation column has a length of 100 to 200 mm, such as around 150 mm.

In some cases, the separation column has a packing material with particle size of 1.0 to 3.0 μm, for example, 1.0 to 2.0 μm, preferably 1.5 to 2.0 μm.

In some cases, the separation column has an internal diameter of 1.5 to 5 mm, preferably 1.5 to 2.5 mm such as around 2.1 mm.

In some cases, the separation column contains a C18 stationary phase.

### Valve Assemblies

The multi-stage apparatus of the invention may further comprise at least one valve assembly, preferably at least two valve assemblies. The valve assemblies may be configured to connect and dis-connect two or more of the modules during operation.

In some embodiments, the apparatus has a first valve assembly configured so that in a first position the buffer exchange module is fluidly connected to the digestion module and in a second position the buffer exchange module is not fluidly connected to the digestion module.

In some embodiments, the apparatus has a second valve assembly configured so that in a first position the trapping column and the separation column are fluidly connected and in a second position the trapping column and the separation column are not fluidly connected.

In some embodiments, the apparatus comprises a first valve assembly; and a second valve assembly. The first valve assembly and the second valve assembly are configured such that the digestion column and the trapping column are fluidly connectable; the trapping column and the separation column are fluidly connectable; and the separation module and the digestion module are not fluidly connectable; and the separation module and the buffer exchange module are not fluidly connectable.

In some such embodiments, the buffer exchange column, the digestion column and the trapping column are fluidly connected when the first valve assembly is in the second position and the second valve assembly is in a first position. The trapping column and the digestion column are not fluidly connected in any other combination of positions of the valve assemblies. The trapping column and the separation column are fluidly connected when the second valve assembly is in a second position. The trapping column and the separation column are not fluidly connected in any other combination of positions of the valve assemblies. The separation module and the digestion module are not fluidly connected in any combination of positions of the valve assemblies. The separation module and the buffer exchange module are not fluidly connected in any combination of positions of the valve assemblies.

A “valve assembly” refers to a multi-port valve component that controls flow between elements connected to the ports. This is typically achieved by a switch mechanism that moves one or more valve conduits to switch communication between different elements. Elements, e.g. components of one or more of the modules, may be fluidically connected to the ports via further conduits, like pipes, tubes, capillaries, microfluidic channels and the like and by fittings like screws/nuts and ferrules, or alternative liquid-tight sealings, e.g., maintained in place by a clamp mechanism. In this way, the various components of the modules may be connected as defined herein. For example, the pump of the trapping module may be connected to the trapping column via the first valve assembly.

The first and second valve assembly may be any a multiport valve with from a 2-7 way switching, preferably 2 way switching.

The first and second valve assembly may be a multiport valve with any of 10, 12, or 14 port valves. Preferably the first valve assembly is a 10 port valve with 2 way switching. Preferably, the second valve assembly is a 10 port valve with 2 way switching.

In some embodiments, the flow through the trapping column may be reversed when the second valve assembly is switched from the first to the second position.

First and second mixers may be fluidly connected to the trapping pump when the first valve is in the second position and the second valve is in the first position.

### Other

Other aspects and embodiments of the invention provide the aspects and embodiments described above with the term “comprising” replaced by the term “consisting of” and the aspects and embodiments described above with the term “comprising” replaced by the term “consisting essentially of”.

It is to be understood that the application discloses all combinations of any of the above aspects and embodiments described above with each other, unless the context demands otherwise. Similarly, the application discloses all combinations of the preferred and/or optional features either singly or together with any of the other aspects, unless the context demands otherwise.

Modifications of the above embodiments, further embodiments and modifications thereof will be apparent to the skilled person on reading this disclosure, and as such, these are within the scope of the present invention.

All documents and sequence database entries mentioned in this specification are incorporated herein by reference in their entirety for all purposes.

“and/or” where used herein is to be taken as specific disclosure of each of the two specified features or components with or without the other. For example, “A and/or B” is to be taken as specific disclosure of each of (i) A, (ii) B and (iii) A and B, just as if each is set out individually herein.

### Process

The present invention also provides a multidimensional LC process for analysing a sample, such as a sample of therapeutic antibodies.

The process is carried out using an apparatus of the invention. The terminology provided for the apparatus above is used below to define the process. Optional and preferred features of the apparatus may be implemented in the process of the invention. For example, the preferred buffer exchange column features of length, internal diameter or particle size disclosed above are also preferred for use in the process of the invention.

The method of comprises the steps of:
1. extracting a portion of a reagent, such as a reducing or alkylating agent, from a reagent vial in the sample module using the needle
2. injecting the portion of the reagent, such as a reducing agent or alkylating agent, into a reaction vial in the sample module and contacting the reagent with a sample to be analysed
3. controlling the temperature of the reaction vial using the sample module and allowing the reaction to occur
4. after reaction occurs, extracting a portion of the reacted sample using the needle and injecting the reacted first sample into the buffer exchange module
5. flowing the reacted first sample through the buffer exchange column, preferably a reverse phase column, to the digestion module
6. digesting the sample on the digestion column and flowing the digested sample to the separation module
7. separating the digested sample for analysis.

The ‘reagent vial’ in the sample module refers to a vial which contains the stock solution of the reagents.

The ‘sample vial’ in the sample module refers to a vial containing the stock solution of the sample to be analysed.

The ‘reaction vial’ in the sample module refers to a vial in which the desired reaction (e.g. reduction and/or alkylation) are carried out in the sample module. The reaction vial is not the vial that contains the stock solution of the reagents. In some cases, the reaction vial may be the vial that contains the stock solution of the sample to be analysed. That is, the reaction vial and the sample vial are the same vial. Preferably, the reaction vial is not the vial which contains the stock solution of the sample to be analysed. That is, preferably the reaction vial and the sample vial are different vials.

Preferably, the method of comprises the steps of:
i. extracting a portion of a reagent, such as a reducing or alkylating agent, from a reagent vial in the sample module using the needle
ii. extracting a portion of a first sample to be analysed from a sample vial in the sample module using the needle
iii. injecting the portion of the reagent, such as a reducing agent or alkylating agent, and the portion of the first sample to be analysed into a reaction vial in the sample module
iv. controlling the temperature of the reaction vial using the sample module and allowing the reaction to occur
v. after reaction occurs, extracting a portion of the reacted sample using the needle and injecting the reacted first sample into the buffer exchange module
vi. flowing the reacted first sample through the buffer exchange column, preferably a reverse phase column, to the digestion module
vii. digesting the sample on the digestion column and flowing the digested sample to the separation module
viii. separating the digested sample for analysis.

In some preferred embodiments, steps (i) and (ii) are carried out before step (iii). In this way, the reagent and the sample to be analysed are contained within the needle at the same time before being deposited into the reaction vial for reacting. Preferably step (i) is carried out before step (ii). In this way, the reagent such as the reducing agent is extracted first to avoid the reagent vial being contaminated.

The sample is flowed through the buffer exchange module, digestion module, optional trapping module and separation module using solvent and one or more pumps.

In some embodiments, steps (i) to (iv) are carried out on a second sample to be analysed when the first sample to be analysed has started step (v). In this way, the process can be streamlined to reduce overall analysis time for multiple samples.

In some embodiments, the separated sample is analysed using mass spectrometry.

In some embodiments, the reagent is selected from reducing agents such as Tris-(2-carboxyethyl)-phosphine (TCEP) or Dithiothreitol (DTT); alkylating agent such as lodacetamide, lodoacetic acid (IAA) or N-Ethylmaleimide (NEM): agents for enzymatic reactions such as deglycosylation with PNGase F or digestion with Papain, Pepsin, IdeS, IdeZ Protease, trypsin or LysC; and labelling reagents. Preferably, the reagent is a reducing agent. In some such embodiments, the reducing agent is tris-(2-carboxyethyl)-phosphine (TCEP). Preferably the reducing agent is in solution, such as a 50% acetonitrile and water, solution in the reagent vial. The reducing agent may be at a concentration of from 10 to 40 mM such as around 25 mM.

In some embodiments, a further reagent is introduced to the reaction vial, preferably the further reagent is an alkylating agent. The further reagent is added by extracting a portion of the further reagent from a further reagent vial in the sample module using the needle. The further reagent may be added to the reaction vial after the (initial) reagent has reacted with the sample to be analysed. The further reagent is added before step (v) and is allowed to react before step (v) is carried out.

In some embodiments, an alkylating agent is used such as lodacetamide, lodoacetic acid (IAA) or N-Ethylmaleimide (NEM). Preferably, the alkylating agent is N-ethylmaleimide (NEM). Preferably the alkylating agent is in solution, such as a 50% acetonitrile and water solution, in the further reagent vial. The alkylating agent may be at a concentration of from 30 to 90 mM such as around 60 mM.

In some embodiments, the sample vial is in a first area of the sample holder. In some embodiments, the reagent vial(s) is in a first area of the sample holder. The reagent vial(s) includes the further reagent vial. In some embodiments, the reaction vial for carrying out the reaction is in a second area of the sample holder.

In some embodiments, the first area of the sample holder is cooled. In some embodiments, the second area of the sample holder is heated to a temperature for reacting the sample and reagents.

The sample holder may have a cooling or heating device as discussed above, such as a Peltier device, for controlling the temperature of the vials. Preferably, the sample module has at least two heating or cooling devices, such as two Peltier devices, for controlling the temperature in the first and second areas of the sample module separately and independently.

In this way, the temperature of the reaction vial can be controlled independently of the temperature of the sample vial and reagent vial(s). This means, the reaction vial can be heated as needed to promote reaction whilst maintain the stock solutions of the sample and reagents at a lower temperature to prevent unwanted reaction. The temperature of the reaction vial may be controlled to be from 0 to 100° C., such as from 0 to 70° C. or such as from 35 to 65° C. The temperature of the sample vial and reagent vial may be from 0 to 30° C. such as from 2 to 8° C. That is, the sample vial and reagent vial may be cooled or kept at close to room temperature.

In some embodiments, the needle is washed between samples. In this way, cross contamination of samples or reagents is avoided and the process can be carried out on multiple different samples or using different reagent to provide reliable results.

In some embodiments, the sample flows through a biocompatible mixer after injection and before entering the buffer exchange module. The mixer allows dilution of the sample to be analysed. In this way, the organic solvents and any by-products from the reaction are reduced before the sample is passed on to the buffer exchange column.

In some embodiments, the sample flows off the buffer exchange column through a T-piece before entering the digestion column. In some such embodiments, the T-piece introduces digestion buffer to the sample as it passes through the T-piece to dilute the sample before it enters the digestion column. In this way, the sample solution is optimised before passing onto the digestion column to provide improved digestion and increase the lifetime of the digestion column.

The sample to be analysed may be any kind of protein or polypeptide sample. For example, the sample to be analysed may be a sample of: enzymes; hormones; small proteins; multi-subunit proteins; virus proteins such capsid proteins e.g. from Adeno-associated virus group (AAV) for gene therapy; antibodies such as therapeutic antibodies for examples monoclonal antibodies; or protein mixtures containing multiple different proteins. In preferred embodiments, the sample to be analysed is a sample of a biological pharmaceutical such as a therapeutic antibody.

In the process a first valve assembly and a second valve assembly may be used to:
provide fluid connection between the buffer exchange module and the digestion module; and
prevent fluid connection between the separation column and digestion column.

In some embodiments, the process further comprises the step of analysing the fractions of the sample as they flow off the separation column by mass spectrometry.

### Examples

In this application, a novel multi-stage (LC) apparatus is provided that allows multi attribute measurements to be obtained from a single sample.

The novel apparatus allows time efficient multi attribute measurements of mAb samples.

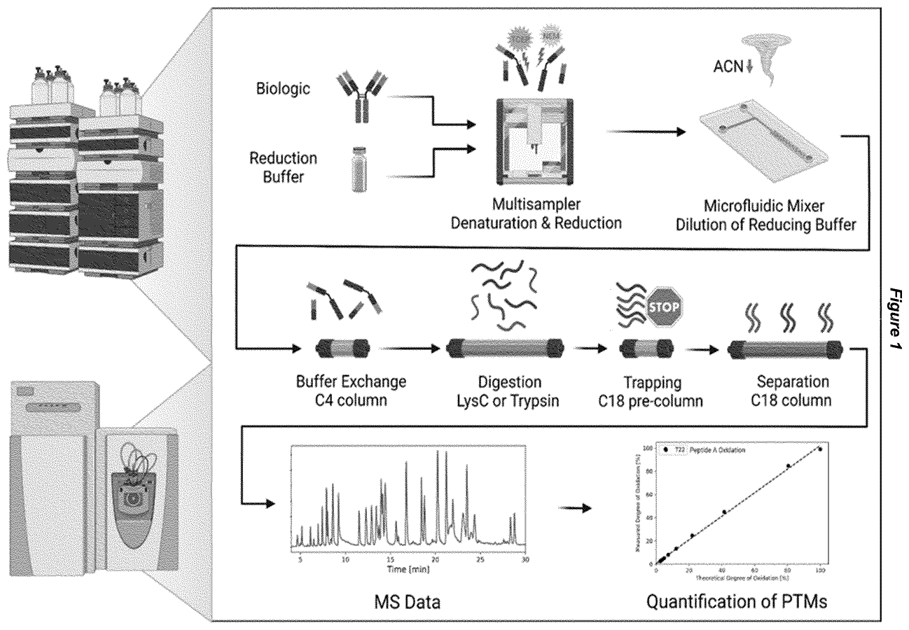

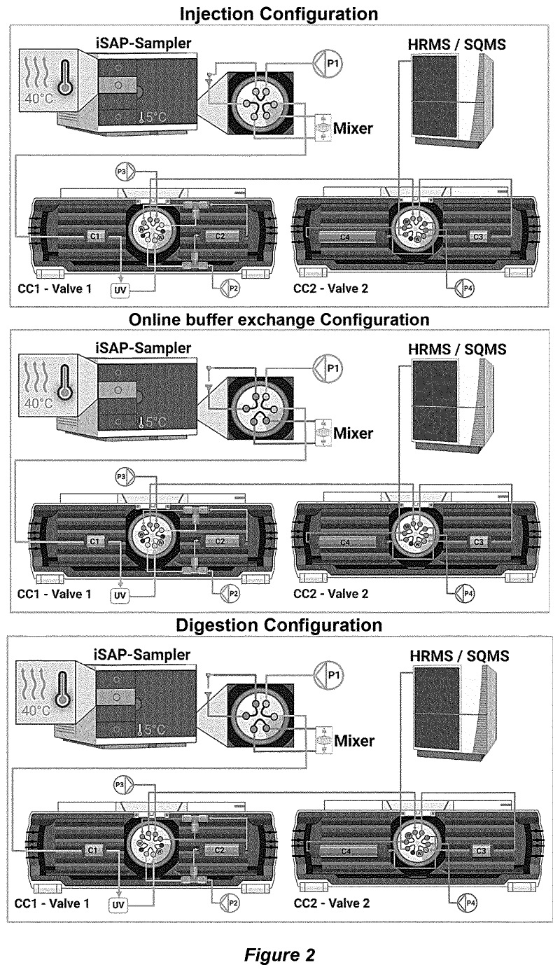

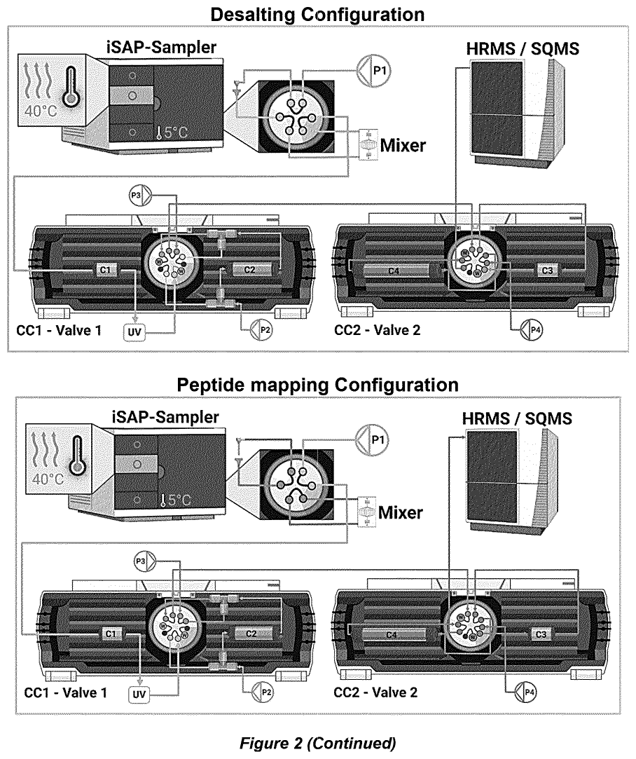

The term “iSAP-LC-MS” used in the application and in particular the examples refers to an apparatus of the invention combining online, integrated sample preparation (“iSAP”) with integrated LC-MS. In the Examples the specific apparatus used in the experiments is outlined in FIG. 1 and in more detail in FIG. 2.

### Materials

### Reagents

The following reagents were using in the examples:

| Reagent | Manufacturer | CAS No. |
|---|---|---|
| Tris(hydroxymethyl) | Merck | 77-86-1 |
| aminomethane | | |
| (TRIS) | | |
| 2-Propanol | VWR | 67-63-0 |
| Acetonitrile (ACN) | Merck | 75-05-08 |
| Ammoniumacetate | Sigma-Aldrich | 631-61-8 |
| Calciumcloride | Merck | 10035-04-8 |
| dihydrate (CaCl₂) | | |
| Formic acid (FA) | Fluka | 64-18-6 |
| L-Histidine | Merck | 5934-29-2 |
| L-Methionine | Merck | 63-68-3 |
| Methanol | Merck | 67-56-1 |
| N-Ethylmaleimide | Merck | 128-53-0 |
| (NEM) | | |
| Phosphoric Acid | Acros Organics | 7664-38-2 |
| Tris(2- | Merck | 51805-45-9 |
| caboxyethyl)phosphine | | |
| (TCEP) | | |
| Trypsin (modified | Roche | 11418025001 |
| sequencing grade) | | |

| | |
|---|---|
| Purified Water (Milli- | Merck Millipore (Merck KGaA, Darmstadt, |
| Q H₂O) | Germany) Milli-Q Advantage A10 system |

### Monoclonal Antibodies

mAb1 refers to the drug product of a phase 3 IgG monoclonal antibody provided by F. Hoffmann-La Roche.

### Apparatus and Methods

iSAP-LC-MS Instrument

The iSAP-LC-MS instrument is based on 1290 Infinity II Bio LC modules from Agilent Technologies incorporating a modified Multisampler, two binary pumps, two quaternary pumps, two UV detectors and two column ovens with integrated 2-position 10-port valves (Supporting Table S1). The Apparatus is controlled by the GMP compliant software Chromeleon 7.2.10 ES from Thermo Fisher Scientific.

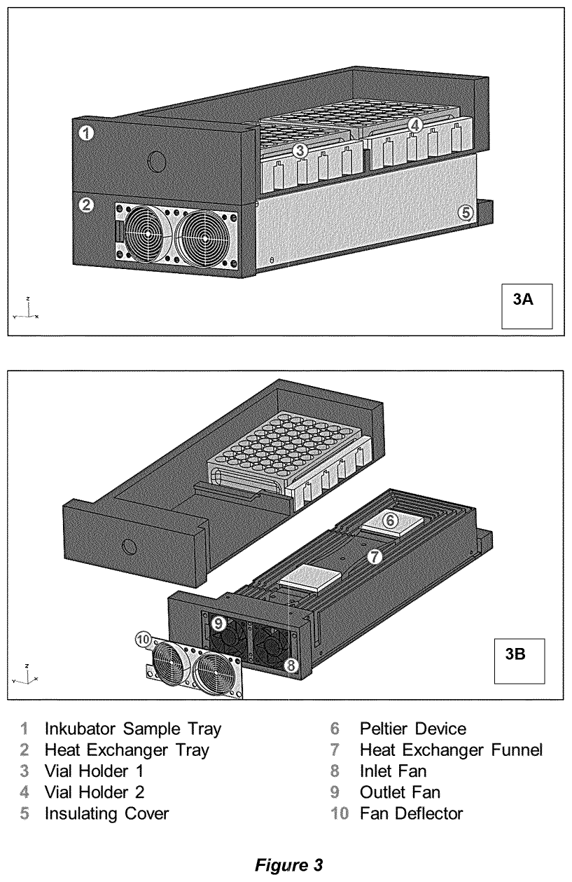

To enable the reduction and alkylation within the multisampler a custom made incubator was incorporated into the upper sample tray by placing two Peltier devices beneath the sample tray to produce an incubator which were integrated into the software. This multisampler was invented, developed and produced in house and is shown in FIGS. 3A and 3B. The sample tray modification is shown in FIG. 3. FIG. 3A shows the sample module with tray (1) having two sample holder trays (3 and 4), the sample module has a heat exchanger module (2) below the sample tray with an insulating cover (5). The heat exchanger module is shown in more detail in FIG. 3B with Peltier device (6) for temperature control and heat exchange funnels (7) also for assisting with temperature control. Inlet fan (8), and outlet fan (9) are provided for heat exchange from the apparatus to the environments along with fan deflector (10) covering the fans.

The connection to the software allows setting the temperature between 0° C. and 70° C. which is automatically maintained due to integrated temperature sensors and control elements. Additionally, a time table in the software allows to change the temperature within a run for specific applications.

The Multisampler was further modified by installation of a biocompatible microfluidic mixer (see ‘Mixer’ in FIG. 2; a Jetweaver 100 μL Agilent Technologies) between the needle seat and the injector valve to reduce the organic solvent concentration after injection.

Custom made valve configuration and flow paths were also used as shown in FIGS. 1 and 2. The valve set up is shown in FIG. 2 and consists of two valve assembles, vale 1 and valve 2.

The iSAP-LC-MS apparatus uses a novel backflush mode for the pre-C18 trapping column, to further increase the elution efficiency.

iSAP-LC-MS Method

The iSAP-LC-MS method (FIG. 1) consists of a liquid handling program of the modified multisampler and the LC modules for online sample preparation and analysis. The operating conditions for each module are provided in the tables below.

The sample preparation starts with the injector program (ip) of the multisampler by aliquotation of the sample into a fresh vial and dilution with denaturation and reduction buffer (ip-Buffer1: 25 mM tris-(2-carboxyethyl)-phosphine (TCEP) in 50% acetonitrile (ACN) in Milli-Q water). After incubation for 20 minutes by 40° C., the reduced sample is alkylated by transferring alkylation buffer (ip-Buffer2: 60 mM N-ethylmaleimide (NEM) in acetonitrile (ACN)) to the reaction sample vial and allowing it to react for 20 minutes by 40° C.

The reduced and alkylated sample is injected into the (LC) apparatus for online buffer exchange for 1 min on a C4 pre-column (ACQUITY UPLC Protein BEH C4 VanGuard Pre-column 2.1×5 mm, Waters, Corporation). Afterwards, the valve 1 (see FIG. 2) switches and the reduced and alkylated sample is eluted for 2 min from the C4 pre-column. The eluting mAb chains are diluted with digestion buffer (50 mM TRIS, 10 mM CaCl2) via a T-piece before entering the trypsin or LysC immobilized enzyme reactor (IMER, Trypsin or LysC 2.1×33 mm, Perfinity Biosciences). The samples are digested for 1 min and the received peptides are trapped on an C18 pre-column (ACQUITY UPLC BEH C18 VanGuard Pre-column 2.1×5 mm Waters Corporation). Next the valve 1 (see FIG. 2) switches back and the trapped peptides are desalted for 1 min.

Subsequently the peptide mapping analysis starts by switching valve 2 (see FIG. 2), which results in the inline connection of the pre-column, the analytical C18 column (ACQUITY UPLC BEH C18 Column (2.1×150 mm, Waters Corporation) and the used MS-instrument (I-IV). Additionally, the sample preparation of the next sample is started in-parallel and is finished simultaneously with the peptide mapping analysis of the previous sample.

Modules of the iSAP-LC-MS System - All liquid chromatography
modules are from Agilent Technologies and controlled by the
Chromeleon 7.2.10 ES software from Thermo Scientific. All solvents
are continuously degassed, using an in-line degasser.

| Module | Product | Product Number |
|---|---|---|
| Autosampler | 1290 Bio Multisampler | G7137A |
| Pump 1 OBE | 1290 Infinity II Bio High-Speed | G7132A |
| | Pump | |
| Pump 2 Digestion | 1290 Infinity II Bio Flexible Pump | G7131A |
| Pump 3 Desalting | 1290 Infinity II Bio Flexible Pump | G7131A |
| Pump 4 Pepmap | 1290 Infinity II Bio High-Speed | G7132A |
| | Pump | |
| UV detector | 1290 Infinity II VWD | G7114B |
| iSAP-Incubator | Modified 1200 TCC | G1316A |
| Column compartment | 1290 Infinity II MCT | Column compartment: |
| 1 | 1290 Infinity Bio, 2-position/10-port | G7116B |
| Integrated 10 Port | | Valve: 5067-6682 |
| Valve | | |
| Column compartment | 1290 Infinity II MCT | Column compartment: |
| 2 | 1290 Infinity Bio, 2-position/10-port | G7116B |
| Integrated 10 Port | | Valve: 5067-6682 |
| Valve | | |
| Microfluidic mixer | Bio Jet Weaver 35/100 μl | G7132-68135 |
| MS start signal | 1200 Infinity Universal Interface Box | G1390B |
| interface | | |
| High resolution mass | Waters Xevo G2-S QTof | 715001948 |
| spectrometer | | |
| Single quadrupole | Thermo Scientific ISQ EM | ISQEM-ESI |
| mass spectrometer | | |

Online Reduction Autosampler: The table below shows the sample
preparations steps of the iSAP-Multisampler for automated sample
reduction. Automated sample reduction with the 1290 Bio Multisampler.
Before each step, that includes a change of solvent, an external
rinse of the needle is performed to reduce carry-over (not
shown in table). Reduction buffer contained 20 mM TCEP in 50%
ACN and 50 mM Ammonium acetate buffer.

| Function | Comment |
|---|---|
| Draw 25 μl needle wash | Internal rinse of injection |
| | needle |
| Eject needle wash to waste | |
| Draw 31.5 μl reduction buffer | |
| Draw 3.5 μl sample | Sample concentration: |
| | 5 mg/ml |
| Eject 35 μl into an empty reaction vessel | Sample concentration: |
| | 0.5 mg/ml |
| Draw 15 μl from reaction vessel (repeat | Mixing step |
| 10 times) | |
| Eject 15 μl into reaction vessel (repeat 10 | Mixing step |
| times) | |
| Wait 40 min for reduction only | Reaction step |
| (after 20 min alkylation step can be | |
| performed) | |
| Extended needle wash for 2 min | External rinse of injection |
| | needle |
| Draw 10 μl reduced sample | |
| Inject 10 μl | |

Online Buffer Exchange: Online buffer exchange was performed,
using the Acquity UPLC Protein BEH C4 BEH column (2.1 ×
5 mm, 1.7 μm, 300 Å Waters) at 80° C. Elution
of reduced mAb sample was monitored with a 1290 Infinity II
UV-detector at 214 nm and 280 nm. The table below shows flowrates
and flow compositions for the corresponding binary pump.

| | | Eluent A | Eluent B | |
|---|---|---|---|---|
| Time | Flowrate | H₂O + 0.1% FA | ACN + 0.1% FA | Comment |
| [min] | [ml/min] | [%] | [%] | [—] |
| 0 | 0.1 | 95 | 1 | Load |
| 0.01 | 2.5 | 95 | 1 | Load |
| 1 | 2.5 | 95 | 1 | Load |
| 1.01 | 0.6 | 40 | 60 | Elution |
| 1.49 | 0.6 | 40 | 60 | Elution |
| 1.5 | 0.06 | 40 | 60 | Elution |
| 4 | 0.06 | 40 | 60 | Elution |
| 4.01 | 0.001 | 95 | 5 | |
| 5 | 0.001 | 95 | 5 | |
| 5.01 | 0.1 | 95 | 5 | |
| 6 | 0.1 | 1 | 99 | Cleaning |
| 6.01 | 0.1 | 95 | 5 | Cleaning |
| 7 | 0.1 | 1 | 99 | Cleaning |
| 7.01 | 0.1 | 95 | 5 | Cleaning |

Repeat cleaning steps up to minute 21

| | | | | |
|---|---|---|---|---|
| 20.01 | 0.1 | 95 | 5 | Cleaning |
| 21 | 0.1 | 1 | 99 | Cleaning |
| 36 | 0.1 | 1 | 99 | Cleaning |
| 36.01 | 0.1 | 99 | 1 | Re-equilibration |
| 48 | 0.1 | 99 | 1 | Re-equilibration |

Online Tryptic Digestion: the table below shows the flow rates
and flow compositions of the quaternary pump for online tryptic
digestion of the mAb sample. For this a 2.1 × 33 mm trypsin
immobilized enzyme reactor (Perfinity) was used at 40° C.

| | | Eluent A | | |
|---|---|---|---|---|
| | | 50 mM Tris buffer + | Eluent B | |
| Time | Flowrate | 10 mM CaCl₂ pH 8.5 | ACN | Comment |
| [min] | [ml/min] | [%] | [%] | [—] |
| 0 | 0.25 | 99 | 1 | |
| 0.01 | 0.25 | 99 | 1 | |
| 5 | 0.25 | 99 | 1 | Start signal MS |
| 5.01 | 0.1 | 50 | 50 | Cleaning |
| 21 | 0.1 | 50 | 50 | Cleaning |
| 21.01 | 0.1 | 99 | 1 | |
| 26 | 0.1 | 99 | 1 | |
| 26.01 | 0.1 | 99 | 1 | |
| 43 | 0.1 | 99 | 1 | |
| 44 | 0.25 | 99 | 1 | |
| 45 | 0.25 | 99 | 1 | |

Peptide Trapping: Peptide trapping prior to reversed phase
separation was carried out with a Acquity UPLC Protein BEH
C4 BEH column (2.1 × 5 mm, 1.7 μm, 300 Å Waters)
at 80° C. Peptide trapping on pre-column, temperature
was lowered to 20° C. after trapping and cleaning steps
to improve column lifetime. Corresponding flowrates and flow
compositions are displayed in the table below.

| | | | | C | D | |
|---|---|---|---|---|---|---|
| | | A | B | H₂O + | ACN + | |
| Time | Flow | ddH₂O | ACN | 0.1% FA | 0.1% FA | Comment |
| [min] | [ml/min] | [%] | [%] | [%] | [%] | [—] |
| 0 | 0.2 | 0 | 0 | 10 | 90 | |
| 0.01 | 1.5 | 99 | 1 | 0 | 0 | |
| 2.01 | 1.5 | 99 | 1 | 0 | 0 | |
| 5 | 1.5 | 99 | 1 | 0 | 0 | Change to |
| | | | | | | 80° C. |
| 5.01 | 0.1 | 0 | 0 | 1 | 99 | |
| 6 | 0.1 | 0 | 0 | 99 | 1 | |
| 7 | 0.1 | 0 | 0 | 1 | 99 | |
| 8 | 0.1 | 0 | 0 | 99 | 1 | |
| 9 | 0.1 | 0 | 0 | 1 | 99 | |
| 10 | 0.1 | 0 | 0 | 50 | 50 | |
| 41 | 0.1 | 0 | 0 | 50 | 50 | Change to |
| | | | | | | 20° C. |
| 41.01 | 1 | 0 | 0 | 1 | 99 | |
| 42 | 1 | 0 | 0 | 1 | 99 | |
| 42.01 | 1 | 0 | 0 | 99 | 1 | |
| 43 | 1 | 0 | 0 | 1 | 99 | |
| 43.01 | 1 | 0 | 0 | 99 | 1 | |
| 44 | 1 | 0 | 0 | 1 | 99 | |
| 44.01 | 1 | 0 | 0 | 99 | 1 | |
| 45 | 1 | 0 | 0 | 1 | 99 | |

Reversed Phase Separation: Reversed phase separation for online
peptide mapping was carried out using an Acquity Premier Peptide
BEH C18 column (2.1 × 150 mm, 1.7 μm, 300 Å, Waters)
at 40° C. with the gradient displayed in the table below.

| | | A | B | |
|---|---|---|---|---|
| Time | Flow | ddH₂O | ACN | |
| [min] | [ml/min] | [%] | [%] | Comment |
| 0 | 0.4 | 99 | 1 | |
| 0.01 | 0.4 | 99 | 1 | |
| 5 | 0.4 | 99 | 1 | |
| 10 | 0.4 | 85 | 15 | |
| 17 | 0.4 | 81 | 19 | |
| 34 | 0.4 | 65 | 35 | |
| 38 | 0.4 | 30 | 70 | |
| 39 | 0.4 | 30 | 70 | |
| 39.1 | 0.4 | 99 | 1 | |
| 40.1 | 0.4 | 0 | 100 | |
| 40.2 | 0.4 | 99 | 1 | |
| 41.2 | 0.4 | 0 | 100 | |
| 41.3 | 0.4 | 99 | 1 | |
| 45 | 0.4 | 99 | 1 | |

Mass Spectrometer Parameters for MS Acquisition: the table below
shows the setting for the high resolution mass spectrometer Xevo
G2-S QTof from Waters for MS acquisition. The high resolution MS
was controlled, using the MassLynx software (Waters). The start
of MS acquisition was induced by a digital contact closure signal
from the universal interface box (UIBII) from Agilent Technologies.

| Parameter | Condition | |
|---|---|---|
| Ionization mode | ESI+ | |
| Capillary voltage | 3 | kV |
| Cone voltage | 30 | V |
| Offset voltage | 80 | V |
| Source temperature | 150° | C. |
| Desolvation temperature | 350° | C. |
| Cone gas flow | 100 | L/h |
| Desolvation gas flow | 800 | L/h |
| Scan time | 0.5 | s |
| MS mode | positive | |
| Scan range | 200-2000 | m/z |

Mass Spectrometer Settings for MS/MS Acquisition: the table below
shows the setting for the high resolution mass spectrometer Xevo
G2-S QTof from Waters for MS acquisition. The high resolution MS
was controlled, using the MassLynx software (Waters). The start of
MS acquisition was induced by a digital contact closure signal from
the universal interface box (UIBII) from Agilent Technologies.

| | |
|---|---|
| Parameter | Condition |

| Ionization mode | ESI+ | |
|---|---|---|
| Capillary voltage | 3 | kV |
| Cone voltage | 30 | V |
| Offset voltage | 80 | V |
| Source temperature | 150° | C. |
| Desolvation temperature | 350° | C. |
| Cone gas flow | 100 | L/h |
| Desolvation gas flow | 800 | L/h |
| Scan time MS | 0.5 | s |
| Scan time MS/MS | 0.3 | s |
| MS mode | positive | |
| Scan range MS | 200-2000 | m/z |
| Scan range MS/MS | 50-2000 | m/z |

| | |
|---|---|
| Fragmentation | Collision induced fragementation |

Single Quadrupole Mass Spectrometer Parameters for MS Acquisition:
the table below shows the setting for the single quadrupole mass
spectrometer ISQ EM from Thermo Scientific for MS acquisition.
The MS was controlled, using the Chromeleon software.

| Parameter | Condition |
|---|---|
| Ionization mode | ESI+ |
| Source voltage | 3 kV |
| Vaporizer | 227° C. Sheath gas |
| Ion transfer tube | 300° C. Aux gas |
| Full scan + (SIM) | 200-2000 m/z , scan time 0.5 s |
| Single ion monitoring | Mass list |

### Experiments

A 5 mg/ml sample of mAB1 (recombinant monoclonal IgG-Antibody produced in CHO-cells with human glycosylation profile) was prepared in a sample vial by diluting to in an buffer formulation and placed in a sample holder.

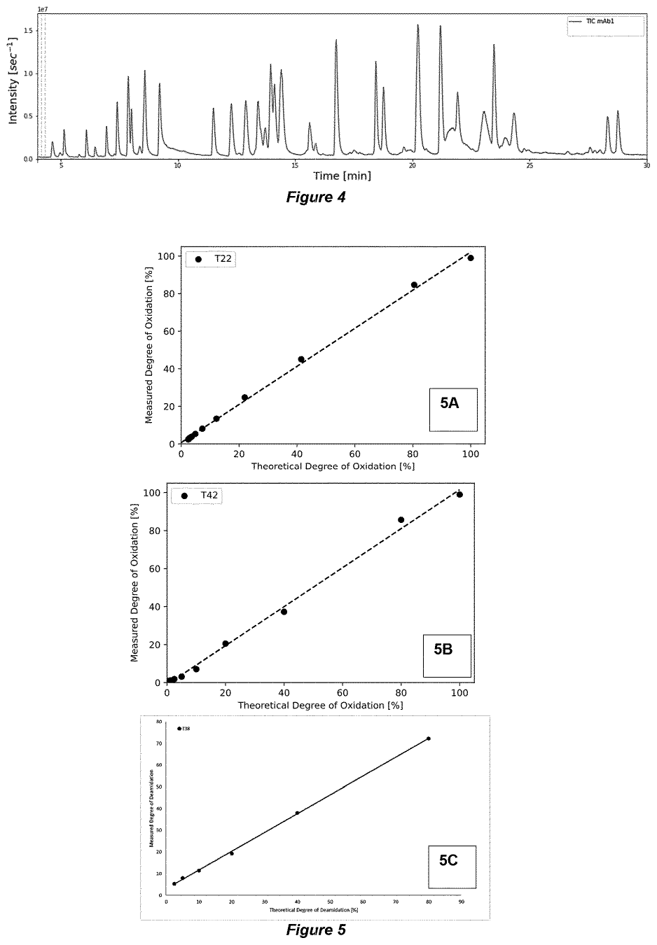

The sample was processed according to the above method. The total ion chromatogram of mAB1 prepared and analyzed with the iSAP-LC-MS is shown in FIG. 4.

The linearity of the system was tested. Linearity assessment was carried out using mAB1 tryptic peptide oxidation (T22 or T42) or deamination quantification. Samples of mAB1 with 10 different oxidation levels and samples with 10 different deamination levels were prepared and measured.

For forced oxidation, mAbs were incubated in 20 mM Histidine buffer, pH 6.0 with 0.2% H₂O₂ for 24 h at 25° C. For forced deamidation, samples were incubated in 200 mM Tris-HCl buffer pH 9.0 for 7 days. After incubation, each stressing was stopped by buffer exchange into fresh 20 mM Histidine, 20 mM Methionine buffer pH 6.0 to a final concentration of 0.5 mg/ml, using NAP 5 columns. These forced stress samples were defined as 100% stress level.

An unstressed reference standard was defined as 0% stress level. Through mixing of 0% and 100% stress level the intermediate stress levels (0.16%, 0.31%, 0.63%, 1.25%, 2.5%, 5%, 10%, 20%, 40%) where generated. Each level is corrected by the measured oxidation for level 0.00 (2.43%). Thereafter each level is measured and compared to the theoretical corrected oxidation level.

Data for the degree of T22 oxidation is shown in the following table and in FIG. 5A.

| Oxidation Level | Theoretical Oxidation | Measured Oxidation |
|---|---|---|
| % | (corrected) % | % |
| 0.00 | — | 2.43 |
| 0.16 | 2.59 | 2.54 |
| 0.31 | 2.73 | 2.91 |
| 0.63 | 3.04 | 3.26 |
| 1.25 | 3.65 | 3.90 |
| 2.50 | 4.87 | 5.27 |
| 5.00 | 7.31 | 8.10 |
| 10.00 | 12.19 | 13.44 |
| 20.00 | 21.94 | 24.73 |
| 40.00 | 41.46 | 45.07 |

The fitted linearity of the measured degree of oxidation for T22 has a correlation factor of R²=0.9987. The measured data is plotted against the normalized theoretical degree of oxidation. Normalization was performed using the degree of oxidation from the unstressed sample, which is 2.43% for T22.

Data for the degree of T42 oxidation is shown in FIG. 5B. The fitted linearity of the measured degree of oxidation for T42 has a correlation factor of R²=0.9992. Because T42 is not oxidized in the unstressed sample no normalization was necessary. The point with 0.63% theoretical oxidation was the lowest point, where oxidation of T42 was verified.

Data for the degree of deamination is shown in FIG. 5C. The fitted linearity of the measured degree of deamidation has a correlation factor of R²=0.995. The measured data is plotted against the theoretical degree of deamidation

In summary, the results show very good linearity within the tested range.

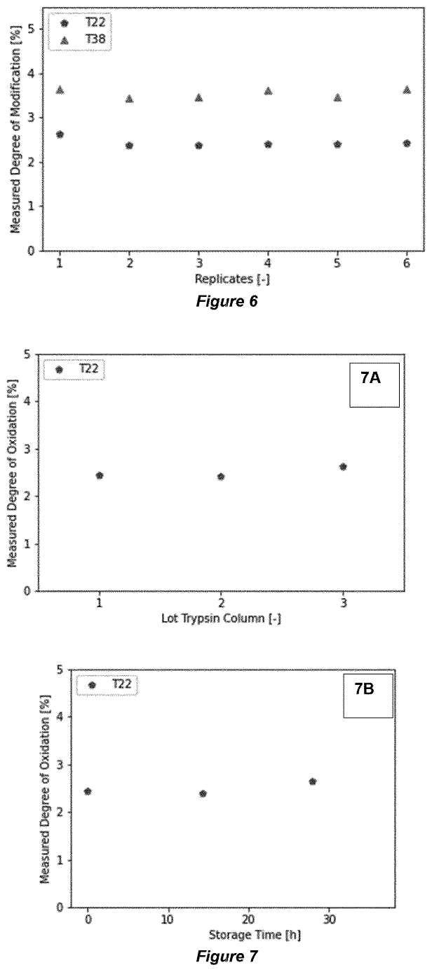

The precision of the system was tested by injecting an identical sample of mAB1 with 0% stress level (reference standard) six times. The degree of two modification (T22 and T38) for each sample was obtained for comparison. The results are shown in the table below and in FIG. 6.

| Replicate | T22 Oxidation [%] | T38 Deamidation [%] |
|---|---|---|
| 1 | 2.6 | 3.7 |
| 2 | 2.4 | 3.5 |
| 3 | 2.4 | 3.5 |
| 4 | 2.4 | 3.6 |
| 5 | 2.4 | 3.5 |
| 6 | 2.4 | 3.6 |

The degree of oxidation for T22 of the non-stressed mAb had a RSD of 2.51% (see pentagons in FIG. 6). The first replicate has a higher measured degree of oxidation, compared to the latter 5 replicates. T38 of the Deamidation stress had a RSD % of 3.62% (see triangles in FIG. 6). Overall, the relative standard deviation calculated for the oxidation and deamination are low with values under 10% and show a good precision of the used instrument and method.

The robustness of the digestion in the system was tested using three different lots of trypsin columns and by storing the mAB1 sample for 0 h, 12 h and 24 h before sample preparation. The process was run using a mAB1 in the iSAP-Autosampler sample through three different trypsin columns (each in triplicate). Oxidation of T22 was compared for the different trypsin columns and the results are shown in FIG. 7A. The process was run using mAB1 samples that were prepared and used immediately (i.e. zero storage time) and at 12 and 24 hours storage time and at around 30 hours storage time (each in triplicate). Oxidation of T22 was compared for different storage times columns. The results are shown in the tables below and in FIG. 7B. No significant change in oxidation was observed.

| Trypsin | % Oxidation T22 | Mean Oxidation |
|---|---|---|
| IMER Lot | [%] | T22 [%] |
| 1 | 2.4 | 2.4 |
| | 2.5 | |
| | 2.4 | |
| 2 | 2.5 | 2.4 |
| | 2.4 | |
| | 2.4 | |
| 3 | 2.7 | 2.6 |
| | 2.5 | |
| | 2.7 | |

| Storage Time | % Oxidation T22 | Mean Oxidation |
|---|---|---|
| iSAP | [%] | T22 [%] |
| 0 h | 2.6 | 2.5 |
| | 2.4 | |
| | 2.4 | |
| 12 h | 2.4 | 2.4 |
| | 2.3 | |
| | 2.4 | |
| 24 h | 2.8 | 2.5 |
| | 2.7 | |
| | 2.4 | |

### Discussion

The iSAP-LC-MS platform allows a second sample to be prepared whilst the first is digested and mapped which increases the throughput of the apparatus. This is shown schematically in FIG. 8A. In particular, the iSAP-LC-MS platform provides increased sample throughput compared to the use of known apparatuses such as Pipetting robot protocols. This is illustrated in FIG. 8B.

Cost and environmental aspects are also improved using the multi-stage apparatus of the invention compared to known pipetting robot protocols (FIGS. 8C and 8D).

The iSAP-LC-MS platform showed good linearity, accuracy and reproducibility. Similar results were obtained compared to our manual and robotic workflow, while the iSAP LC-MS apparatus showed good robustness in terms of autosampler storage time and IMER efficiency.

The iSAP-LC-MS apparatus could accelerate analysis, reduce workload and contribute to making more drugs available at a lower cost.

### CLAUSES

The following numbered clauses provide some specific embodiments of the invention.
1. A multi-stage apparatus comprising
   an injector module having a needle
   a sample module having a sample tray for holding one or more sample vials
   a buffer exchange module having a buffer exchange column
   a digestion module having a digestion column downstream from the buffer exchange module; and
   a separation module having a separation column downstream from the digestion module
   wherein the injector module is configured for the needle to extract and inject a sample from one sample vial into another sample vial and to extract and inject a sample from a sample vial into the buffer exchange module; and
   wherein the sample module is configured to control the temperature of the sample vials such that in use a sample can be reacted by introducing reagents and the sample to a vial in the sample tray using the needle and controlling the temperature before being injected to the buffer exchange module.
2. The multi-stage apparatus of any one of the preceding clauses wherein the injector module is a pipetting robot.
3. The multi-stage apparatus of any one of the preceding clauses wherein the injector module is configured to move portions of the sample to a new vial.
4. The multi-stage apparatus of any one of the preceding clauses wherein the injector module is configured to draw the reagent, such as a reducing agent, into the needle and then draw the sample into the needle.
5. The multi-stage apparatus of any one of the preceding clauses wherein the needle has a volume of at least 3 μL.
6. The multi-stage apparatus of any one of the preceding clauses wherein the sample module has a heating or cooling device, such as a Peltier device, for controlling the temperature of the vials.
7. The multi-stage apparatus of clause 6 wherein the sample module has at least two heating or cooling devices, such as two Peltier devices, for controlling the temperature in different regions of the sample module.
8. The multi-stage apparatus of any one of the preceding clauses wherein the sample module comprises two samples trays configured so that the temperature of each sample tray is independently controllable.
9. The multi-stage apparatus of any one of the preceding clauses wherein the sample tray(s) can hold 54 vials or have 96 well plates per tray.
10. The multi-stage apparatus of any one of the preceding clauses wherein the sample module comprises sample vials for holding samples and for holding reagents such as reducing agents.
11. The multi-stage apparatus of any one of the preceding clauses wherein the sample module is an autosampler or a multisampler.
12. The multi-stage apparatus of any one of the preceding clauses wherein the buffer exchange column is a reverse phase column such as a C4 column, a C1 column or a phenyl stationary phase column.
13. The multi-stage apparatus of any one of the preceding clauses further comprising a trapping module having a trapping column for holding the sample after digestion in the digestion module wherein the trapping module between digestion module and separation module in the direction of flow.
14. The multi-stage apparatus of clause 13 wherein the trapping column has a length of 5 to 30 mm.
15. The multi-stage apparatus of clause 13 or 14 to wherein the trapping column has a packing material with particle size of 1.0 to 3.0 μm, for example 1.0 to 2.0 μm preferably 1.5 to 2.0 μm.
16. The multi-stage apparatus of any one of clauses 13 to 15 to wherein the trapping column has an internal diameter of 1.5 to 5 mm.
17. The multi-stage apparatus of any one of clauses 13 to 16 to wherein the trapping column has the same packing material as the peptide mapping column.
18. The multi-stage apparatus of any one of the preceding clauses wherein the separation column is selected from a peptide mapping column such a UHPLC column or a HPLC column, a hydrophilic interaction chromatography column, preferably, the separation column is a UHPLC column.
19. The multi-stage apparatus of any one of the preceding clauses wherein the separation column has a C18 stationary phase.
20. The multi-stage apparatus of any one of the preceding clauses wherein the separation column has a length of 100 to 200 mm, such as around 150 mm.
21. The multi-stage apparatus of any one of the preceding clauses wherein the separation column has a packing material with particle size of 1.0 to 3.0 μm, for example 1.0 to 2.0 μm preferably 1.5 to 2.0 μm.
22. The multi-stage apparatus of any one of the preceding clauses wherein the separation column has an internal diameter of 1.5 to 5 mm, preferably 1.5 to 2.5 mm such as around 2.1 mm.
23. The multi-stage apparatus of any one of the preceding clauses wherein the separation column contains a C18 stationary phase.
24. The multi-stage apparatus of any one of the preceding clauses wherein the digestion column is selected from a Trypsin immobilized enzyme reactor, a LysC immobilized enzyme reactor, or an aspN immobilized enzyme reactor.
25. The multi-stage apparatus of any one of the preceding clauses wherein the digestion module has a first mixer such as static mixer or a zero delay volume T-Piece after the digestion column(s) in the direction of flow.
26. The multi-stage apparatus of clause 25 wherein the first and second mixer are fluidly connectable to the trapping pump.
27. The multi-stage apparatus of any one of the preceding clauses wherein the digestion module has a second mixer such as static mixer or a zero delay volume T-Piece before the digestion columns in the direction of flow.
28. The multi-stage apparatus of any one of the preceding clauses wherein the digestion module comprising two digestion columns preferably the two digestion columns are connected in parallel.
29. The multi-stage apparatus of any one of the preceding clauses wherein the two digestion columns are connected in parallel such that in use the sample flow is split between the two columns.
30. The multi-stage apparatus of clause 28 or 29 wherein the two digestion columns are a Trypsin immobilized enzyme reactor and a LysC immobilized enzyme reactor.
31. The multi-stage apparatus of any one of the preceding clauses further comprising an analysis module for analysing the sample after the sample has passed through the separation column.
32. The multi-stage apparatus of clause 31 wherein the analysis module comprises: a mass spectrometer such as a high-resolution mass spectrometer (HRMS) or a single quadrupole mass spectrometer; an evaporative light scattering detector (ELSD): a UV detector; or a diode array detector (DAD).
33. The multi-stage apparatus of any one of the preceding clauses further comprising a biocompatible microfluidic mixer between the needle and the valve for injecting the sample into the buffer exchange module or between the injector valve and the buffer exchange module.
34. The invention also provides a process for analysing a sample using the multi-stage apparatus of any one of the preceding clauses.
35. The process of clause 34 comprising the steps of:
   i. extracting a portion of a reagent, such as a reducing or alkylating agent, from a reagent vial in the sample module using the needle
   ii. extracting a portion of a first sample to be analysed from a sample vial in the sample module using the needle
   iii. injecting the portion of the reagent, such as a reducing agent or alkylating agent, and the portion of the first sample to be analysed into a reaction vial in the sample module
   iv. controlling the temperature of the reaction vial using the sample module and allowing the reaction to occur
   v. after reaction occurs, extracting a portion of the reacted sample using the needle and injecting the reacted first sample into the buffer exchange module
   vi. flowing the reacted first sample through the buffer exchange column, preferably a reverse phase column, to the digestion module
   vii. digesting the sample on the digestion column and flowing the digested sample to the separation module
   viii. separating the digested sample for analysis.
36 The process of clause 35 wherein steps (i) and (ii) are carried out before step (iii), preferably wherein step (i) is carried out before step (ii).
37. The process of clause 35 or 36 wherein steps (i) to (iv) are carried out on a second sample to be analysed when the first sample to be analysed has started step (v).
38. The process of any one of clauses 35 to 37 wherein the separated sample is analysed using mass spectrometry.
39. The process of any one of clauses 35 to 38 wherein the reagent is selected from a reducing agent, an alkylating agent or a labelling agent, preferably, the reagent is a reducing agent.
40. The process of any one of clauses 35 to 39 wherein a further reagent is introduced to the reaction vial, preferably the further reagent is an alkylating agent.
41. The process of any one of clauses 35 to 40 wherein the sample vial is in a first area of the sample holder
42. The process of any one of clauses 35 to 41 wherein the reagent vial(s) is in a first area of the sample holder
43. The process of any one of clauses 35 and 42 wherein the reaction vial for carrying out the reaction is in a second area of the sample holder.
44. The process of any one of clauses 41 to 43 wherein the first area of the sample holder is cooled
45. The process of any one of clauses 41 to 44 wherein the second area of the sample holder is heated to a temperature for reacting the sample and reagents.
46. The process of any one of clauses 35 to 45 wherein the needle is washed between samples.
47. The process of any one of clauses 35 to 46 wherein the sample flows through a biocompatible mixer after injection and before entering the buffer exchange module.
48. The process of any one of clauses 35 to 47 wherein the sample flows off the buffer exchange column through a T-piece before entering the digestion column.
49. The process of clause 48 wherein the T-piece introduces digestion buffer to the sample as it passes through the T-piece to dilute the sample before it enters the digestion column.
50. The process of any one of clauses 35 to 49 wherein the sample to be analsed is a sample of a biological pharmaceutical such as a therapeutic antibody.

1. A multi-stage apparatus comprising
an injector module having a needle
a sample module having a sample tray for holding one or more sample vials
a buffer exchange module having a buffer exchange column
a digestion module having a digestion column downstream from the buffer exchange module; and
a separation module having a separation column downstream from the digestion module
wherein the injector module is configured for the needle to extract and inject a sample from one sample vial into another sample vial and to extract and inject a sample from a sample vial into the buffer exchange module; and
wherein the sample module is configured to control the temperature of the sample vials
such that in use a sample can be reacted by introducing reagents and the sample to a vial in the sample tray using the needle and controlling the temperature before being injected to the buffer exchange module.

2. The multi-stage apparatus of claim 1 wherein the injector module is a pipetting robot preferably the injector module may comprise a robotic 3-axis arm for liquid handling.

3. The multi-stage apparatus of any one of the preceding claims wherein the injector module is configured to move portions of the sample to a new vial.

4. The multi-stage apparatus of any one of the preceding claims wherein the injector module is configured to draw the reagent, such as a reducing agent, into the needle and then draw the sample into the needle.

5. The multi-stage apparatus of any one of the preceding claims wherein the sample module has a heating or cooling device, such as a Peltier device, for controlling the temperature of the vials.

6. The multi-stage apparatus of claim 5 wherein the sample module has at least two heating or cooling devices, such as two Peltier devices, for controlling the temperature in different regions of the sample module.

7. The multi-stage apparatus of any one of the preceding claims wherein the sample module comprises two samples trays configured so that the temperature of each sample tray is independently controllable.

8. The multi-stage apparatus of any one of the preceding claims wherein the sample tray(s) can hold 54 vials or have 96 well plates per tray.

9. The multi-stage apparatus of any one of the preceding claims wherein the buffer exchange column is a reverse phase column such as a C4 column, a C1 column or a phenyl stationary phase column.

10. The multi-stage apparatus of any one of the preceding claims further comprising a biocompatible microfluidic mixer between the needle and the valve for injecting the sample into the buffer exchange module or between the injector valve and the buffer exchange module.

11. The multi-stage apparatus of any one of the preceding claims further comprising an analysis module for analysing the sample after the sample has passed through the separation column preferably wherein the analysis module comprises: a mass spectrometer such as a high-resolution mass spectrometer (HRMS) or a single quadrupole mass spectrometer; an evaporative light scattering detector (ELSD): a UV detector; or a diode array detector (DAD).

12. A process for analysing a sample using the multi-stage apparatus of any one of the preceding claims.

13. The process of claim 12 comprising the steps of:
i. extracting a portion of a reagent, such as a reducing or alkylating agent, from a reagent vial in the sample module using the needle
ii. extracting a portion of a first sample to be analysed from a sample vial in the sample module using the needle
iii. injecting the portion of the reagent, such as a reducing agent or alkylating agent, and the portion of the first sample to be analysed into a reaction vial in the sample module
iv. controlling the temperature of the reaction vial using the sample module and allowing the reaction to occur
v. after reaction occurs, extracting a portion of the reacted sample using the needle and injecting the reacted first sample into the buffer exchange module
vi. flowing the reacted first sample through the buffer exchange column, preferably a reverse phase column, to the digestion module
vii. digesting the sample on the digestion column and flowing the digested sample to the separation module
viii. separating the digested sample for analysis.

14. The process of claim 13 wherein steps (i) and (ii) are carried out before step (iii), preferably wherein step (i) is carried out before step (ii).

15. The process of claim 13 or 14 wherein steps (i) to (iv) are carried out on a second sample to be analysed when the first sample to be analysed has started step (v).
